(19) United States
(12) Patent Application Publication
(10) Pub. No.: US 2020/0412193 A1
(43) Pub. Date: Dec. 31, 2020

(54) STATOR

(71) Applicant: Miba eMobility GmbH, Laakirchen (AT)

(72) Inventor: Andreas EILENBERGER, Lengenfeld (AT)

(73) Assignee: Miba eMobility GmbH, Laakirchen (AT)

(21) Appl. No.: 16/976,935

(22) PCT Filed: Mar. 27, 2019
(86) PCT No.: PCT/AT2019/060106

§ 371 Date: Aug. 31, 2020

(30) Foreign Application Priority Data
Mar. 27, 2018 (AT) A50260/2018
Aug. 24, 2018 (AT) A50729/2018

(51) Int. Cl. H02K 3/24; H02K 9/19; H02K 11/25

(52) U.S. Cl. CPC H02K 3/24; H02K 11/25; H02K 9/19

(57) ABSTRACT

The invention relates to a stator (1) for an electrical machine, with multiple grooves (5) for receiving at least one electrical conductor (6) each, wherein at least one coolant channel (7) is arranged in each of at least some of the grooves (5) in addition to the at least one electrical conductor (6), and a potting compound is (8) is arranged in the residual volume of the grooves (5). At least some of the coolant channels (7) are flow-connected to one another in the region of at least one axial stator front face (9), via at least one collecting channel (10) having at least one collecting channel wall (11).

The invention relates to a stator for an electrical machine with multiple grooves for receiving at least one electrical conductor each, wherein at least one coolant channel is arranged in each of at least some of the grooves in addition to the at least one electrical conductor, and a potting compound is arranged in the residual volume of the grooves.

The invention further relates to an electrical machine comprising a stator.

Furthermore, the invention relates to a method for producing a stator for an electrical machine, in which multiple grooves for receiving at least one electrical conductor each are formed, wherein at least one coolant channel is formed in each of at least some of the grooves in addition to the at least one electrical conductor, and the residual volume of the grooves is filled with a potting compound.

The invention also relates to a potting tool for filling the grooves for each receiving at least one electrical conductor of a stator for an electrical machine with a potting compound, comprising a core rod, by means of which the potting compound can be pushed into the grooves, as well as multiple mold rods or mold pipes, which can be introduced into the grooves for forming coolant channels.

Finally, the invention also relates to a device for inserting electrical conductors into a stator or rotor for an electrical machine, comprising feed elements for the introduction of the electrical conductors into the grooves of a laminated core for producing the stator or rotor.

It is known that, in a stator of an electrical machine in operation, heat is generated on the one hand in the laminated core and on the other hand in the windings. For this reason, stators are cooled, wherein the prior art describes most diverse embodiments of cooling systems.

A highly effective cooling system is one that brings the cooling medium in immediate proximity of the heat sources. For example, DE 10 2014 213 159 A1 describes an arrangement for cooling a stator in an electrical motor with a stator laminated core, comprising a plurality of stator laminations axially arranged in a row as well as multiple winding grooves extending axially in the stator laminated core for receiving associated stator windings, wherein a radial recess formed in one of the stator laminations opens into each of the winding grooves, wherein the radial recess communicates with a coolant line provided on the stator laminated core for feeding coolant.

US 2011/0133580 A1 describes an embodiment variant of a groove cooling in which coolant channels are formed in the potting compound for the groove, which potting compound is inserted for insulation reasons. The advantage of this is that no additional cooling channels need to be drilled or corresponding pipelines need to be provided for this. However, this document does not clarify how the cooling channels can be integrated into the further coolant supply.

The object of the present invention is to create an improved groove-cooled stator for an electrical machine.

The stator mentioned initially achieves the object of the invention through the fact that at least some of the coolant channels are flow-connected to one another in the region of at least one axial stator front face, via at least one collecting channel having at least one collecting channel wall.

The object is further achieved with the initially mentioned electrical machine, in which the stator is formed according to the invention.

Moreover, the invention is achieved by the initially mentioned method, according to which it is provided that at least some of the coolant channels are flow-connected to one another in the region of at least one axial stator front face, via at least one collecting channel, which is formed with at least one collecting channel wall.

The invention is also achieved with the initially mentioned potting tool, on which at least one covering is arranged, wherein a mold element is arranged, for forming a collecting channel, with which at least individual ones of the coolant channels can be flow-connected.

Moreover, the object of the invention is also achieved with the initially mentioned device for inserting electrical conductors into a stator or rotor for an electrical machine, in which, additionally, at least one feed element for introducing mold rods or mold pipes into the grooves is arranged as a placeholder for forming coolant channels.

The advantage of this is that, by means of the front-side distribution of the coolant to the coolant channels, a compact possibility of feeding coolant into the grooves of a stator can be achieved. This makes it possible to use the installation space available for the electrical machine for increasing the achievable power. With this, the integration of the coolant channels into the cooling system is also easier to represent.

By already introducing the placeholders for the coolant channels in the “winding machine” for the insertion of the electrical conductors, the method for producing the stator of an electrical machine can be significantly simplified as an additional work step is no longer necessary. Furthermore, this makes the automated distribution of the groove volumes to the conductors and the placeholders for the coolant channels realizable with a lower chance of a misarrangement.

According to one embodiment variant of the stator and/or the method, it can be provided that the at least one collecting channel wall is made at least partially of a polymer and/or is made at least partially of a polymer or its precursor in order to influence the magnetic field of the electrical machine as little as possible during operation. Additionally, this can improve the corrosion resistance of the cooling system.

According to a preferred embodiment variant of the stator and/or the method, it can be provided that the polymer is made of the potting compound for the grooves and/or that the at least one collecting channel wall is made from the potting compound for the grooves. Hence, the compatibility of the materials used in the stator can be improved, in particular with regard to different thermal expansions. Moreover, hence, the economic efficiency of the method can be improved and consequently the production cost of the stator can be reduced.

A further advantage is, if, according to a further embodiment variant of the stator and/or the method, the at least one collecting channel wall and the potting compound in the grooves are formed integrally and/or in a single piece. Hence, the system integrity can be improved. In particular, leakages can thereby be better avoided.

As an additional effect, the at least one collecting channel wall can be used as a protection for the stator according to a further embodiment variant, for which it can be provided that the at least one collecting channel wall covers the stator front face in its entirety.

According to another embodiment variant of the stator, it can be provided that the collecting channel is formed as an annular channel, whereby said collecting channel can be produced more easily from the potting compound and/or a polymer and/or its precursor.

According to further embodiment variant of the stator, the at least one collecting channel wall can also be used for casting a contacting for the electrical conductors and/or a temperature sensor into it, whereby a further reduction of the production cost of the stator can be achieved. Moreover, with the aid of the temperature sensor, a predeterminable temperature level of the stator in operation can be maintained by integrating the sensor in a corresponding closed loop control and/or open loop control of cooling of the stator.

Preferably, during the method for forming the coolant channels before the insertion of the potting compound, mold rods or mold pipes are introduced into the grooves, and, additionally, the electrical conductors are inserted into the grooves also before inserting the potting compound. Thus, placeholders for introducing the electrical conductors into the grooves are not required.

In doing so, according to a further embodiment variant, the mold rods or mold pipes for forming the coolant channels are inserted in a device, in which the electrical conductors are also inserted into the grooves. As previously described, an additional workstation can be saved by this, whereby the course of the method can be simplified.

According to a further embodiment variant, it can also be provided, that the mold rods or mold pipes are inserted into the grooves after the electrical conductors or simultaneously with the electrical conductors. Hence, it is possible to slightly move the electrical conductors within the grooves by inserting the mold rods or mold pipes, so that, simultaneously with the insertion of the mold rods or mold pipes, a positioning of the electrical conductors in the grooves can take place.

For the purpose of better understanding of the invention, it will be elucidated in more detail by means of the figures below.

These show in a simplified schematic representation:

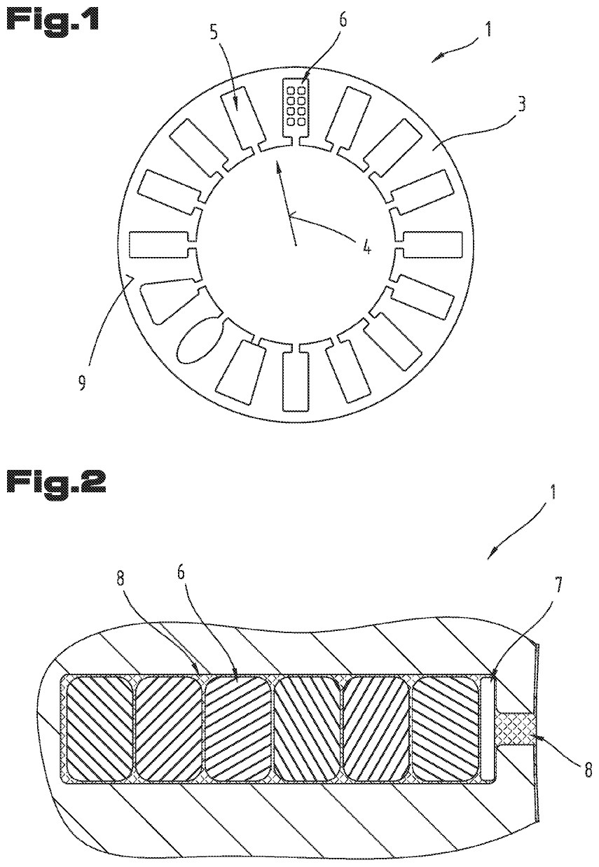

FIG. 1 a view of a stator in an axial direction;

FIG. 2 a cutout of a stator in the region of a groove for receiving the electrical conductors;

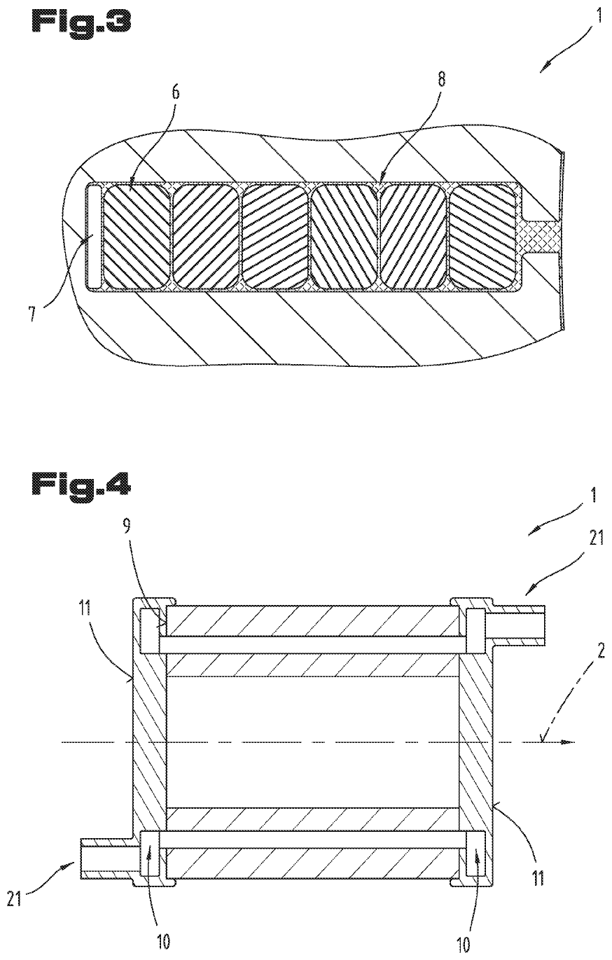

FIG. 3 a cutout of an embodiment variant of the stator in the region of a groove for receiving the electrical conductors;

FIG. 4 a stator in a sectional side view;

FIG. 5 an embodiment variant of the stator in a front view;

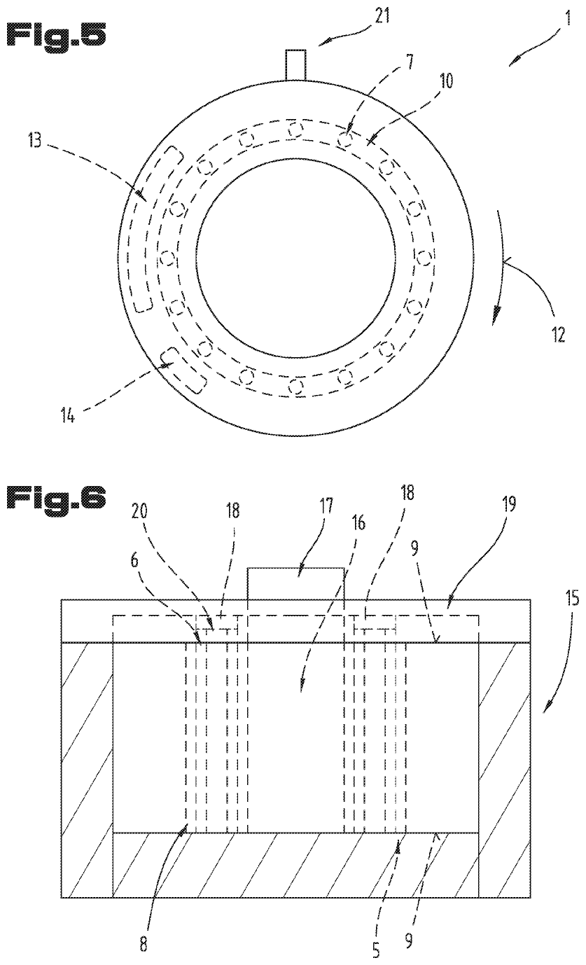

FIG. 6 a partial section of an embodiment variant of the potting tool.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a stator 1 for an electrical machine in a front side view. The electrical machine is, in particular, a motor or a generator.

In principle, such electrical machines as well as the stators used therefore are known from the prior art, so that regarding further details, reference is made to the relevant prior art. For the sake of completeness, it should be noted at this point, that the electrical machine preferably also comprises a rotor, which is arranged in the electrical machine forming an air gap with the stator 1. For example, the rotor can be arranged on a shaft in a rotationally secure manner During operation of the electrical machine formed as an electrical motor, the rotor is set into a rotational movement due to the generated magnetic fields. However, in principle, the stator 1 can be used for creating a rotating field even without a rotor.

The rotor itself can be formed according to the prior art.

The stator 1 comprises a number of sheet metal elements 3 (in particular electrical sheets) arranged in a row in an axial direction 2 (FIG. 4), which are connected to one another to form a laminated core, as it is per se known. In these sheet metal elements 3, inwardly open grooves 5 are arranged in a radial direction 4. The exact number of grooves 5 depends on the desired size and/or power of the electrical machine.

The grooves 5 can have the most different cross-sectional shapes (as viewed in the direction of the axial direction 2), as is adumbrated in FIG. 1 based on grooves 5, which are shown in the left bottom quadrant. For example, the grooves 5 can have a round, an oval, a rectangular, a square, a trapezoidal etc. cross-sectional shape. However, it should be noted that the grooves 5 of a stator 1 all preferably have the same cross-sectional shape, although mixed variants with at least two different cross-sectional shapes are possible.

The radially inward end region of the grooves 5 is formed to be open. This region is preferably designed to be most narrow, so that the grooves 5 consequently become outwardly wider in the radial direction 4 (respectively viewed in the cross-section in the radial direction 4).

The grooves 5 serve for receiving at least one electrical conductor 6 per groove 5. The electrical conductors 6 form the stator windings. These are merely adumbrated in a groove 5 in FIG. 1.

The electrical conductors 6 can be made from a wire. The wire can be designed, for example, as a round wire (FIG. 1) or as a flat wire (FIG. 2). Likewise, the stator windings 6 can be designed preferably as so-called hair pins or I pins.

One or multiple electrical conductors 6 can be provided per groove 5, as is adumbrated in FIG. 1 by way of example of four electrical conductors 6 or in FIGS. 2 and 3 by way of example of six electrical conductors 6. The specific number of electrical conductors 6 shown, however, is not to be understood as limiting. Further, the specific location and its orientation of the electrical conductors 6 within the grooves 5, as shown in the fig., is not to be understood as limiting.

In addition to the electrical conductors 6, at least one coolant channel 7 is arranged in at least some of the grooves 5, preferably in all grooves 5. These coolant channels 7 serve for receiving a cooling fluid, in particular a cooling liquid, which flows through these coolant channels 7 for cooling the stator 1.

If needed, multiple coolant channels 7 can be arranged in at least individual ones of the grooves 5, for example two or three, which, where applicable are also flown through by the cooling fluid in different directions.

The exact position of the coolant channel 7, as it is shown in the figures, is not to be understood as limiting. Likewise, the cross-sectional shape shown is not to be understood as limiting. The coolant channels can be designed to be circular, oval, rectangular, square etc. (respectively viewed in the cross-section in the radial direction 4).

Preferably, the at least one coolant channel 6 is arranged and/or formed in the groove 5, following the radially inner beginning of the groove 5 (in particular, outward in the radial direction 4 and following the constricted region of the groove 5), as it is shown in FIG. 2, or in the groove 5 and (directly) following the radially outer base of the groove, as it is shown in FIG. 3.

Preferably, the stator 1 is manufactured by means of the full potting method, as will be further explained in the following. In the method, the space between the electrical conductors 6 in the grooves 5 is filled with a potting compound 8, as it is shown in FIG. 2 and/or FIG. 3 based on a cutout of the stator 1 in the region of a groove 5. The potting compound can correspond with the prior art, for example be a thermosetting casting resin. Examples for such casting resins are polyester resins, epoxy resins etc..

It is now provided that at least some of the coolant channels 7, preferable all coolant channels 7, are connected to one another in the region of at least one axial stator front face 9 via at least one collecting channel 10, which has at least one collecting channel 11, as it can be seen in FIG. 3.

The at least one collecting channel 10 serves for feeding the cooling fluid to the collecting channels 7. After the cooling fluid is distributed to the coolant channels 7 via the collecting channel 10, said collecting channel 10 can also be called a distributing channel.

Although in principle, it is possible that the cooling fluid is removed individually per coolant channel 7 from the coolant channels 7 on the end of the stator 1, which end is positioned opposite the at least one collecting channel 10 along the axial direction 2, the embodiment is preferred, in which a collecting channel 10 with at least one collecting channel wall 11 is arranged also on this other end region, in which collecting channel 10 the cooling fluid is collected for further transport, e. g. to a heat exchanger of the cooling system, as it is shown in FIG. 3.

At least individual ones, in particular all of the coolant channels 7 extend from the collecting channel 10 on the front side of the stator 1 through the grooves 5 in the sheet metal elements 3 in the axial direction 2 and open into the second collecting channel 10 on the front side of the stator 1. In this regard, the coolant channels 7 are preferably exclusively formed by the groove filling, that is in particular the potting compound 8, i. e. no separate pipelines and/or hose lines are provided for this. Therefore, the side walls of the coolant channels are formed by the groove filling, in particular the potting compound 8.

In principle, however, it is possible, although not preferred, that the coolant channels 7 are formed by separate pipelines and/or hose lines, which are introduced into the grooves 5 before they are filled.

In the afore-described embodiment variant of the stator 1 the cooling fluid flows from one front side to the other front side of the stator 1 and subsequently leaves the stator 1 on this front side. Thus, the supply and the discharge of the cooling fluid to and from the stator 1 takes place on different sides of the stator 1. However, it is also possible that the cooling fluid is diverted on a front side of the stator 1 and then flows through the stator 1 in the opposite direction. The supply and discharge of the cooling fluid can therefore also take place on one front side of the stator 1. For this case, only some of the coolant channels 7, in particular half of the total amount each, on each of the two front sides of the stator 1 are connected to the respective collecting channel 10 for the supply and/or discharge of the cooling fluid. The collecting channel 10 for supplying the cooling fluid to and the collecting channel 10 for discharging the cooling fluid from the coolant channels 7 are arranged on one front side of the stator 1. On the second front side of the stator 1, a further collecting channel 10 can be located. However, it is also possible that the coolant channels 7 have a diversion on this second front side of the stator 1, thus, for example, are formed to be U-shaped.

Although producing the collecting channel 10 and/or the collecting channels 10 from the potting compound 8, with which also the grooves 5 are potted, is the preferred embodiment variant of the stator 1, a polymer or its precursor can generally be used for its production. Further, it is also possible, that a polymer or its precursor is used for filling the grooves 5, in particular the polymer that is used, where applicable, for producing the at least one collecting channel 10. In the case of using a precursor for the polymer, it can be polymerized after filling the grooves 5. The potting compound 8, however, is usually cross-linked.

Within the meaning of the invention, a polymer is understood to be a material consisting of organic, synthetic or natural macromolecules of interconnected monomers.

The collecting channel side wall 11 consists preferably to 100% of the polymer and/or the potting compound 8. However, it is also possible, that additives are added to the polymer or the potting compound 8, for example ceramic or metal filaments, in order to achieve a stiffening of the collecting channel side wall 11. Likewise, other stiffening elements, for example grid-shaped or rod-shaped stiffening elements, can be embedded into the collecting channel side wall 11.

The collecting channel 10 and/or the collecting channel wall 11 can be produced as a separate component and subsequently be connected to the coolant channels 7. However, the at least one collecting channel 10, i. e. the at least one collecting channel wall 11, is preferably formed in a single piece with the coolant channels 7, i. e. with the potting compound 8 of the grooves 5.

The at least one collecting channel wall 11 and/or the collecting channel walls 11 can cover only a partial region of the stator front face(s) 9, so that the end laminations of the laminated core of the stator 1 are still partially visible when viewed in the direction of the axial direction 2. However, according to one embodiment variant of the stator 1, it is preferably provided that the at least one collecting channel wall 11 covers the stator front face 9 in its entirety, as is shown in FIG. 5. For the sake of clarity, FIG. 5 does not represent the grooves 5. The dashed lines, however, do show the collecting channel 10 and the end of the coolant channels 7.

FIG. 5 also shows a further preferred embodiment variant of the stator 1, in which the at least one collecting channel 10 is designed to be an annular channel. In principle, the collecting channel 10 can also have a different, suitable form.

With regard to the cross-sectional shape of the collecting channel 10 (as viewed in the direction of a circumferential direction 12 of the stator), that is the open cross-sectional area between the at least one collecting channel wall 11, the channel can be designed to be circular, oval, square, rectangular etc..

According to further embodiment variants of the stator 1, it can be provided that at least one further component is embedded into the at least one collecting channel wall 11. For example, a contacting for the electrical conductors 6 and/or at least one temperature sensor 14 can be cast into the at least one collecting channel wall 11. The contacting 13 and the temperature sensor 14 are shown in FIG. 5, merely adumbrated in dashed lines.

As described above, the method for producing the stator 1 for an electrical machine preferably provides, that in at least multiple of the grooves 5 for receiving the electrical conductors 6, coolant channels 7 are formed by the potting of the grooves 5 with the potting compound 8, and that at least some of the coolant channels 7 in the region of at least one of the axial stator front faces 9 are flow-connected to one another via the at least one collecting channel 10. For producing the collecting channel wall 11, a polymer or its precursor or, in particular, the potting compound 8 can be used to fill the grooves 5.

The potting of the grooves 5 is preferably carried out with the full potting method. In this method, the laminated core provided with the electrical conductors 6 (FIGS. 2 and 3) is put into a potting tool 15, as represented in FIG. 6. The potting compound 8, that is, in particular, a synthetic resin, is filled, among others, into a stator center 16 and afterwards pushed into the grooves 5 (FIG. 1) by insertion of the core rod 17 into the stator center 16. In order to fill the grooves 5 pore-free in doing so, a low-viscosity, degassed potting compound 8 is preferably used. In addition or as an alternative to this, the method can also be carried out under a vacuum in order to further reduce air pockets, for which the potting tool 15 can be put into an appropriate device for evacuation.

In order to be able to produce the coolant channels 7 (FIG. 2) simultaneously with the filling of the grooves 5 with the potting compound 8, mold rods 18 or mold pipes and/or accordingly shaped cores (generally can also be called placeholders) are slid into the grooves 5 and removed after filling the grooves 5 with the potting compound 8 as soon as the potting compound 8 has the necessary strength for that. The mold rods 18 or mold pipes and/or cores can, for example, consist of polytetrafluoroethylene or have a coating of that material.

As already described, the at least one collecting channel wall 11 and with that the collecting channel 10 can be produced separately and connected, for example glued, to the coolant channels 7.

In the preferred embodiment variant of the method for producing the stator 1, however, the at least one collecting channel wall 11 is produced together with the coolant channels 7, that is in a single piece. The potting tool for this can have a covering 19, in which the at least one mold element 20 for forming the at least one collecting channel 10 and the at least one collecting channel wall 11 is arranged and/or formed.

If at least one collecting channel 10 is to be formed on each of the two stator front faces 9 of the stator 1, the potting tool 15 can have a further such covering 19. This can also be formed by the bottom of the potting tool 15.

In general, the grooves 5 can also be filled with the potting compound 8 by means of another method, for example by means of hot dipping or dripping. However, the full potting method is preferred.

The collecting channel 10 and/or the collecting channels 10 are preferably formed as closed channels. It is, however, also possible to produce them, for example, in the form of a half shell and then to close it with another half shell.

The collecting channel 10 or the collecting channels 10 further preferably have at least one connection 21 (FIG. 4, FIG. 5) each, for the supply and/or the discharge of the cooling fluid into and/or out of the collecting channel 10 and/or the collecting channels 10, which connection 21 can be placed at most different locations, as it is shown based on two examples in the figures.

It is preferably provided that, for forming the coolant channels 7, mold rods 18 or mold pipes are introduced into the grooves 5 before the potting compound is inserted into the grooves 5, and that additionally, before the potting compound is inserted into the grooves 5, the electrical conductors 6 are inserted into the grooves 5.

According to a possibly independent embodiment variant of the invention, it can be provided that the mold rods 18 or mold pipes for forming the coolant channels 7 are inserted in a device, in which the electrical conductors 6 are also inserted into the grooves 5. This device can, for example, be a winding machine which is known yet adapted for the insertion of the mold pipes. If, instead of a winding, pins are used as electrical conductors 6, this device can be an appropriate machine, as it is used for introducing the pins into the stator laminations.

Especially when using winding robot for pin and mold rod technology (sometimes also called plug winding), the approach of inserting the electrical conductors 6 together with the placeholders is advantageous for the coolant channels or corresponding cooling pipes.

The device for inserting the electric conductors 6 into the stator or rotor for the electrical machine can in itself be designed customarily, and accordingly have feed elements for introducing the electrical conductors 6 into the grooves 5 of a laminated core for the production of the stator or rotor. Furthermore, the device has, different from devices known from the prior art, and additional at least one feed element for introducing the mold rods 18 or mold pipes into the grooves 5 as placeholders for forming the coolant channels 7. When, in this process, only one feed element is used, all grooves 5 can be equipped with the placeholders simultaneously. For this, the feed element can have a number of fingers corresponding to the grooves 5, on which fingers the mold rods 18 and/or mold pipes are arranged. The relative position of the fingers to one another depends on the position of the grooves 5 in the laminated core.

Alternatively, it is also possible that the mold pipes and/or mold rods 18 are introduced into the grooves 5 individually or in groups, whereby a correspondingly greater number of feed elements is present in front of this. In this, the groups each comprise only a fraction of the total number of mold pipes and/or mold rods 18, wherein the sum of all groups adds up to the total number of mold pipes and/or mold rods 18.

In principle, it can be provided that the electrical conductors 6 are introduced into the grooves 5 after arrangement of the mold rods 18 or mold pipes in them. According to a preferred embodiment variant, however, it can be provided, that the mold rods 18 or mold pipes are inserted into the grooves 5 after the electrical conductors 6 or simultaneously with the electrical conductors 6. In doing so, the grooves 5 can be filled individually with the electrical conductors 6 and the mold rods 18 or mold pipes one after the other, or divided into groups simultaneously, or all grooves 5 simultaneously.

The embodiment variant of the method according to which the mold rods 18 or mold pipes are inserted in the device, in which the electrical conductors 6 are also inserted into the grooves 5, can represent a proper invention in itself, so that it can be designed even without the aforementioned collecting channel 10. Thus, the invention also comprises a method for producing a stator 1 for an electrical machine, in which multiple grooves 5 for receiving at least one electrical conductor 6 each are formed, wherein at least one coolant channel 7 is formed in each of at least some of the grooves 5, in addition to the at least one electric conductor 6, and the residual volume of the grooves 5 is filled with a potting compound 8, wherein the mold rods 18 or mold pipes for forming the coolant channels 7 are inserted in a device, in which the electrical conductors 6 are also inserted into the grooves 5. The embodiment variant according to which at least some of the coolant channels 7 are connected to one another in the region of at least one axial stator front face 9 via at least one collecting channel 10, which is formed with at least one collecting channel wall 11, constitutes an embodiment variant that is preferred over the former, however, not obligatory. Accordingly, the further embodiment variants described above are also applicable to this possibly independent invention according to which the at least one collecting channel 10 is optional. In order to avoid repetitions, reference is therefore made to the explanations above.

The exemplary embodiments show possible embodiment variants, while it should be noted at this point that combinations of the individual embodiment variants are also possible.

Finally, as a matter of form, it should be noted that for ease of understanding of the structure of the stator 1, it is not obligatorily depicted to scale.

### LIST OF REFERENCE NUMBERS

1 stator
2 axial direction
3 sheet metal element
4 radial direction
5 groove
6 conductor
7 coolant channel
8 potting compound
9 stator front face
10 collecting channel
11 collecting channel wall
12 circumferential direction
13 contacting
14 temperature sensor
15 potting tool
16 stator center
17 core rod
18 mold rod
19 covering
20 mold element
21 connection

1. A stator (1) for an electrical machine, with multiple grooves(5) for receiving at least one electrical conductor (6) each, wherein at least one coolant channel (7) is arranged in at least some of the grooves (5) in addition to the at least one electrical conductor (6), and a potting compound (8) is arranged in the residual volume of the grooves (5), wherein at least some of the coolant channels (7) are flow-connected to one another in the region of at least one axial stator front face (9) via at least one collecting channel (10) having at least one collecting channel wall (11).

2. The stator (1) according to claim 1, wherein the at least one collecting channel wall (11) comprises at least in part of a polymer.

3. The stator (1) according to claim 2, wherein the polymer is made from the potting compound (8) for the grooves (5).

4. The stator (1) according to claim 1, wherein the at least one collecting channel wall (11) and the potting compound (8) in the grooves (5) are formed in one piece.

5. The stator (1) according to claim 1, wherein the at least one collecting channel wall (11) covers the stator front face (9) in its entirety.

6. The stator (1) according to claim 1, wherein the collecting channel (10) is formed as an annular channel.

7. The stator (1) according to claim 1, wherein a contacting (13) for the electrical conductors (6) is cast into the at least one collecting channel wall (11).

8. The stator (1) according to claim 1, wherein at least one temperature sensor (14) is cast into the at least one collecting channel wall (11).

9. An electrical machine comprising a stator (1), wherein the stator (1) is formed according to claim 1.

10. A method for producing a stator (1) for an electrical machine, in which multiple grooves (5) for receiving at least one electrical conductor (6) each are formed, wherein at least one coolant channel (7) is formed in at least some of the grooves (5) in addition to the at least one electric conductor (6), and the residual volume of the grooves (5) is filled with a potting compound (8), wherein at least some of the coolant channels (7) are connected to one another in the region of at least one axial stator front face (9) via at least one collecting channel (10), which is formed with at least one collecting channel wall (11).

11. The method according to claim 10, wherein the collecting channel wall (11) is made at least in part from a polymer or its precursor.

12. The method according to claim 10, wherein the at least one collecting channel wall (11) is made from the potting compound (8) for the grooves (5).

13. The method according to claim 12, wherein the at least one collecting channel wall (11) is made from the potting compound (8) in one piece with the potting of the grooves (5).

14. The method according to claim 10, wherein, for forming the coolant channels (7), mold rods (18) or mold pipes are introduced into the grooves (5) before the potting compound is inserted into the grooves (5), and wherein additionally, before the potting compound is inserted into the grooves (5), the electrical conductors (6) are inserted into the grooves (5).

15. The method according to claim 14, wherein the mold rods (18) or mold pipes for forming the coolant channels (7) are inserted in a device, in which the electrical conductors (6) are also inserted into the grooves (5).

16. The method according to claim 14 or 15, wherein the mold rods (18) or mold pipes are inserted into the grooves (5) after the electrical conductors (6) or simultaneously with the electrical conductors (6).

17-18. (canceled)
